(19) United States
(12) Patent Application Publication
(10) Pub. No.: US 2006/0081106 A1
(43) Pub. Date: Apr. 20, 2006

(54) Vibration-type paper cutting device

(76) Inventors: Kazuo Nishimura, Ishikawa (JP); Toshiyuki Majima, Ishikawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/541,489

(22) PCT Filed: Apr. 6, 2004
(86) PCT No.: PCT/JP04/04945

§ 371 Date: Jul. 7, 2005

(30) Foreign Application Priority Data
Apr. 25, 2003 (JP) 2003121136
Dec. 24, 2003 (JP) 2003426958

(51) Int. Cl. B26D 1/12

(52) U.S. Cl. 83/665; 83/956

(57) ABSTRACT

A paper cutting machine for cutting stacked plural paper sheets placed on a table (4). The machine includes a paper holder (2), which moves downward from the above along a vertical guide, a cutter blade (3) for moving upward from below the table (4). As a paper holder mechanism for the paper holder (2), a first nut (8) is screwed to a screw (7) to be rotated by a first motor (10). The first nut (8) and the paper holder (2) are coupled together via a link (5), and the cutter blade (3) is attached to a guide (13) formed with a tilted guide groove (14). An inner slider (15) protruding from the cutter blade (3) is fit to the guide groove (14), and the inner slider (15) engages with and coupled to a vertical groove (25) formed in a moving element (20). The moving element (20) is the one coupled with a second nut (19) screwed to a second screw (16) to be rotated by a second motor (17). Through attachment of eccentric gears (23a, 23b) to change rotation speed of the second screw (16), the machine can be considerably compact in size; be driven by a power-thrifty small-sized motor; and be efficient with shorter cutting time and labor savings. What is more, a cutter blade stopper mechanism prevents the paper sheets from being left uncut, thereby increasing the useful life of the cutter blade to a greater degree.

### TECHNICAL FIELD

The present invention relates to a vibration-type paper cutting machine for cutting stacked plural paper sheets.

### BACKGROUND ART

There are various types of cutting machine for cutting stacked plural paper sheets, and the general type is of configuration-complicated and large-sized. With an exemplary device, stacked 1000 or more of paper sheets is clamped with a paper holder that is lowered for preventing paper displacement. After paper clamp as such, a cutter blade with the angled blade edge is lowered from the above for paper cutting. Cutting the stacked plural paper sheets in a stroke requires a large amount of force. Therefore, the paper holder and the cutter blade are both of a hydraulic-driven type, making full use of a few tons of force for paper cutting. The hydraulic-driven type is not surely the only option, and there is a cutting machine using a motor. The motor of a general type is with an alternating-current power supply of several hundreds to several thousands of watts.

Another issue here is that the paper holder and the cutter blade are both placed at upper positions to lower the cutter blade from the above. This resultantly increases the bulk of the device.

What is more, in a cutting machine of a conventional type, the paper sheets are cut in a stroke by the angled blade edge of the cutter blade reaching one surface of the stacked paper sheets from the other surface. With such a configuration, a stroke is made no matter how many of paper sheets are to be cut. As a result, cutting a thin stack of paper sheets causes the cutter blades to move for nothing, thereby reducing the operation efficiency for paper cutting.

Further, due to the cutter blade with the angled edge, the stacked paper sheets is cut from one surface toward the other surface. At the time of such paper cutting, the paper scraps are curled, and the resulting scrap pieces will be of quite a large amount, causing a need for their elimination. For the purpose, adopted is a method of blowing air or brushing for forced elimination. By including such an auxiliary mechanism for eliminating the paper scraps, the device is resultantly increased in size as a whole.

Still further, in such a case of cutting the stacked paper sheets using the cutter blade with the angled edge, the paper scraps of a plurality of cut paper do not fall until the angled blade edge reaches one surface of the stacked paper sheets to the other. The paper scraps are thus rubbed against the blade edge surface, causing static electricity so that the cut pieces of the paper scraps attach the blade edge. There thus also needs to go through a process of forced elimination by brushing the blade edge, for example.

Still further, in such a case of cutting the stacked paper sheets by lowering the cutter blade from the above, any small-sized paper scraps are left on the table, thereby preventing their free fall. As a result, those paper scraps are rubbed against the blade edge surface, causing static buildup or attachment to the blade edge. There thus needs to go through a method of forced elimination by blowing air or brushing for forced elimination.

Here, in a general case of cutting a to-be-cut object using a cutting tool, such a word as “sharpness” is often used to express the cutting performance of the cutting tool. The sharpness is determined by the size of force (cutting resistance) applied to the cutting tool at the time of cutting, the quality of the cut surface whether the cut surface is damaged or not with any cut streaks or others, the durability of the cutting tool, and the like.

For the cutting resistance, there are three factors including a geometric factor (shape of the cutting tool), a dynamic factor (e.g., cutting method), and a material factor (e.g., material of the cutting tool).

The dynamic factor is represented by representing the cutting resistance Fa with two element resistances as follows:
Fa=Fb+Fc
where Fb: deformation/braking resistance of object to be cut, and
   Fc: friction resistance between object to be cut and cutting tool.

Moreover, it is acknowledged that the cutting resistance of a cutting machine for cutting stacked plural object to be cut (a bundle of sheets, laminated paper, metal foils, thin metal plate layers) varies irregularly according to the variation of the compression resilience being the deformation amount of the object to be cut by the cutting tool, or the variation of the friction. To drive such a cutting machine with a drive motor or others, there needs to set the driving force of the drive motor or others based on the maximum cutting resistance, and to set the durability of the cutting machine itself based also on the maximum cutting resistance.

The conventional paper cutting machine thus becomes large in size and heavy in weight, unable to be equipped inside of office equipment as its auxiliary device.

As such, the conventional paper cutting machine has the problems as described above. The present invention is proposing to solve such problems, and an object thereof is to provide a vibration-type paper cutting machine that is considerably downsized, is driven by a small-sized power-thrifty motor, and is efficient with shorter cutting time and labor savings.

### DISCLOSURE OF INVENTION

A paper cutting machine of the present invention includes: a table for placing thereon stacked plural paper sheets; a cutter blade whose blade edge at an upper end is parallel to a paper-placing surface of the table is disposed beneath the table; a paper holder that freely moves up and down to move downward for pressing down the stacked paper sheets; a vertical guide for sandwiching the paper holder in the vertical direction to freely slide up and down in contact therewith; a first motor for driving the paper holder; a first screw to be rotated by the first motor; a first nut screwed to the first screw; a link for coupling the first nut with the paper holder; a pair of guides each having a diagonally-extending guide groove, and sandwiching the cutter blade to freely slide in contact in the guide groove; a slider that protrudes from the cutter blade vertically to a surface of the cutter blade to engage with the guide groove; and a mechanism for vibrating the slider at a low frequency in a direction along the guide groove. In the machine, the cutter blade is so configured as to freely move up and down while vibrating at the low frequency in the direction along the guide groove.

With such a configuration, the cutter blade moves up in the diagonal direction while vibrating at a low frequency, and can cuts the paper sheets clamped by the paper holder sequentially from the stack bottom sheet by sheet. Further, in response to rotation of the first motor, the first screw rotates, and the first nut screwed to the first screw moves. In response to operation of the link, the paper holder moves up and down.

The slider may be configured by engaging with and coupling to a vertical groove that is formed to a moving element coupled to be a piece with a second nut, which is screwed to a second screw to be rotated by a second motor.

The low-frequency-vibrating mechanism may be configured by a gear mechanism for changing the rotation speed of the second screw. Alternatively, the gear mechanism for changing the rotation speed of the second screw may include a pair of eccentric gears. According to such change of the rotation speed, climbing speed of the cutter blade changes so that it can generate a kind of vibration at a low frequency.

When expressed an angular speed change of the eccentric gears as ω₂/ω₁, a speed change as V, and a center distance as a₁+a₂, it is preferable to represent by an expression below to lengthen the useful life of the cutter blade, and to perform stable paper cutting.
Angular Speed Change: ω₂/ω₁=(1+ε)/(1−ε)˜(1−ε)/(1+ε)
Speed Change: V=2πfr (1±2δ/r)
Center Distance: a₁+a₂=2r˜2r+δ²/r
wherein
   ε=2δ/(a₁+a₂)≅δ/r
   δ: an eccentric volume of the eccentric gears
   f: a rotation speed of the eccentric gears
   a₁: a radius of an eccentric gear 23a
   a₂: a radius of an eccentric gear 23b

For vibration, it is preferable with a low frequency of several tens of hertz (10 to 99 Hz), and oscillation means is not of an electrical type but of mechanical vibration means type as described above.

Further, the machine may further include a cutter base, which moves up and down in response to vertical motion of the cutter blade while being in surface contact with the cutter blade, a first stopper piece attached at both ends of the paper holder, a second stopper piece attached at both upper ends of the cutter base, and when the cutter blade moves up and reaches at a predetermined position, the first and second stopper pieces abut each other, thereby enabling to perform more stable paper cutting without putting too much load to the cutter blade.

Still further, one side of the first stopper pieces and the second stopper pieces may be configured as a screw mechanism, thereby enabling the blade edge of the cutter blade to be adjusted in position when those stopper pieces abut thereto.

### BRIEF DESCRIPTION OF DRAWINGS

FIG. 1 is a front view of a paper cutting machine of a first embodiment of the present invention;

FIG. 2(a) is a cross sectional view along 2(a)-2(a) of FIG. 1;

FIG. 2(b) is a cross sectional view cut along 2(b)-2(b) of FIG. 1;

FIG. 2(c) is a cross sectional view cut along 2(c)-2(c) of FIG. 1;

FIG. 3 is a diagram for illustrating an eccentric gear mechanism that drives a screw for moving a cutter blade in the vertical direction;

FIG. 4 is a front view of a paper cutting machine of a second embodiment of the present invention;

FIG. 5 is a side view of the paper cutting;

FIG. 6 is a cross sectional view along 6-6 of FIG. 4;

FIG. 7 is a diagram for illustrating the arrangement relationship among a paper holder, a cutter blade, and a sheet of paper;

FIG. 8 is an enlarged diagram viewed from the side for illustrating the arrangement relationship among a stopper piece, the cutter blade, and a cutter base; and

FIG. 9 is an enlarged front view of main components of the stopper piece.

### BEST MODE FOR CARRYING OUT THE INVENTION

In the below, embodiments of the present invention are described in detail by referring to the accompanying drawings.

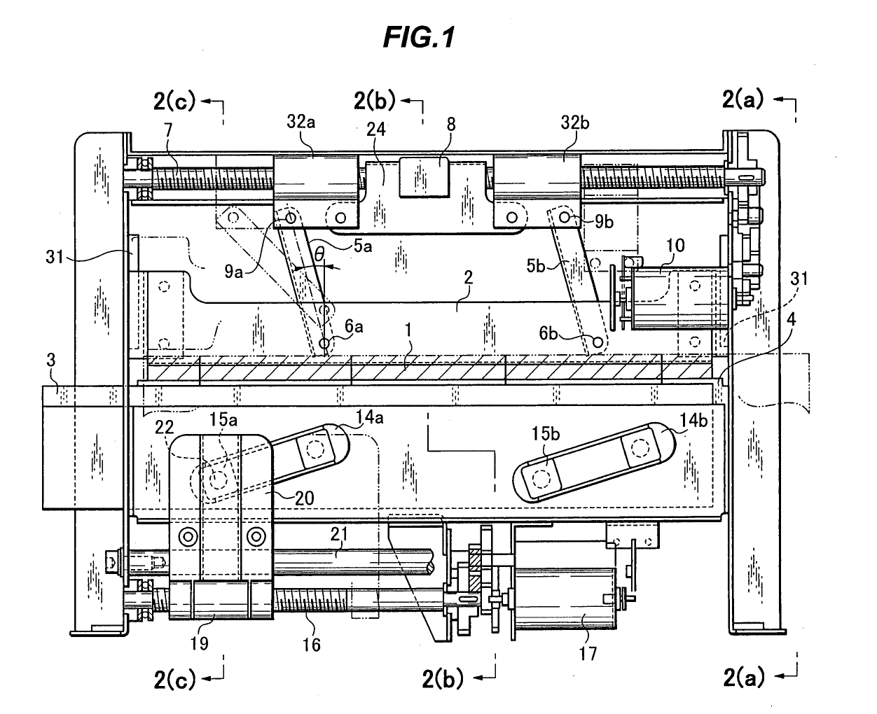

FIG. 1 is a front view of a paper cutting machine of a first embodiment according to the present invention. In the drawing, a reference numeral 1 denotes stacked plural paper sheets, a reference numeral 2 denotes a paper holder that serves to prevent the paper sheets 1 from being displaced, and a reference numeral 3 denotes a cutter blade for cutting the paper sheets 1. The stacked paper sheets 1 is placed on a flat table 4, and the paper holder 2 moves downward. The paper sheets 1 are thus firmly clamped by the paper holder 2 not to displace at the time of paper cutting.

The paper holder 2 is a rod-shaped member that is square in cross section, and abuts the paper sheets over the full-width. A link to the paper holder 2 is established by links 5a and 5b, which are both arranged equidistant from a neutral axis. Via upper link axes 9a and 9b, respectively, the links 5a and 5b are linked to sleeves 32a and 32b screwed to a first screw 7. The sleeves 32a and 32b are coupled to each other by a coupler 24 so as to be retained always with a fixed space therebetween. The coupler 24 is formed with a concave portion at its center, and a first nut 8 fitting therein is screwed to the first screw 7. In response to rotation of the first screw 7, the first nut 8 moves along the first screw 7. As a result, the coupler 24 and the sleeves 32a and 32b coupled with the coupler 24 move with a fixed space thereamong so that the slope angle of the links 5a, 5b is changed.

In FIG. 1, when the sleeves 32a and 32b move toward the right side, the paper holder 2 moves down to press down the paper sheets 1. As is guided at their sides by a vertical guide 31, the paper holder 2 does not move laterally but vertically in response to movement of the sleeves 32a and 32b. The first screw 7 is driven to rotate by a first motor 10, and a plurality of upper gears 11a, 11b are disposed therebetween. With such a configuration, the rotation speed is reduced so that the first screw 7 is rotated slowly.

For example, the stacked paper sheets 1 can be firmly clamped with the first motor 10 having a power supply of DC 24V equivalent to 25 W. Moreover, the slope angle θ of the links 5a, 5b is known through position detection of the sleeves 32a and 32b or the coupler 24. As a result, the thickness can be known for the stacked paper sheets 1 pressed down by the paper holder 2.

The cutter blade 3 is attached beneath the paper holder 2, and is slidably fixed between guides 13a and 13b. The cutter blade 3 slides diagonally, and the guides 13a and 13b are formed with, respectively, guide grooves 14a and 14b with a predetermined space therebetween. These guide grooves 14a and 14b are placed diagonal.

From both side surfaces of the cutter blade 3, inner sliders 15a and 15b are protruding in the horizontal direction, and these inner sliders 15a and 15b are fixed to the guide grooves 14a and 14b with some play. In response to movement of the inner sliders 15a and 15b along the guide grooves 14a and 14b, the cutter blade 3 can slide in the diagonal direction. Here, the inner sliders 15a and 15b supporting the cutter blade 3 move while fitting in the guide grooves 14a and 14b formed parallel each other. Therefore, the cutter blade 3 remains always horizontal. The cutter blade 3 is at its lower position when the inner sliders 15a and 15b are located on the left ends of the diagonally placed guide grooves 14a and 14b. The cutter blade 3 moves up when the inner sliders 15a and 15b slide and move in the right direction.

Beneath the cutter blade 3, a second screw 16 is attached to be horizontal. The second screw 16 is driven to rotate by a second motor 17 via a plurality of lower gears 18a, 18b,—. A second nut 19 screwed to the second screw 16 can be moved in response to rotation of the second screw. From the second nut 19, a moving element 20 rises so as to be engaged with the inner slider 15a. That is, the moving element 20 is formed with a vertical groove 25, and an outer slider 30a is engaged to the vertical groove 25.

The moving element 20 is coupled with the inner slider 15a via an axis pin 22 provided therein, and allowed to move along a guide rod 21 provided parallel to the second screw 16. The second screw 16 is rotated by the second motor 17, and the second nut 19 moves in response to rotation of the second screw 16. The moving element 20 attached with the second nut 19 moves along the guide rod 21. The moving element 20 moves in the horizontal direction along the guide rod 21. On the other hand, the axis pin 22 moves up and down along the vertical groove, and the inner slider 15a is slid along the guide groove 14a. As a result, the cutter blade 3 moves up and down.

With such a configuration, the cutter blade 3 is pushed diagonally up along the guide grooves 14a and 14b, and is allowed to cut off the paper sheets 1 clamped by the paper holder 2 on a paper sheet basis sheet by sheet from underneath. The paper scrap of the paper sheets 1 fall without rubbing continuously against the blade edge surface due to such cutting sheet by sheet, thereby paper scrap does not stick to the blade edge. Here, at the time of cutting the paper sheets 1, the links 5a and 5b serve well for firm clamping to prevent the clamped paper sheets 1 from being displaced in response to moving at the same time both in the upper and lateral directions.

Incidentally, sharpness of the cutter blade is better with the smaller cutting resistance between the cutter blade and the paper sheets. There are two cutting methods; one is “thrust cutting” technique in which the cutter blade is thrust in the direction at right angles to the blade edge line, and the other is “pull cutting” technique in which the cutter blade is thrust while moving parallel to the blade edge line. The present invention applies a method emphasizing the latter “pull cutting” technique. Herein, the dummy point angle (effective wedge angle) β of the cutter blade is represented by the following expression:
tan β=V/(V²+v²)^{1/2}·tan γ

where γ denotes the point angle (wedge angle) of the cutter blade, V denotes the speed (thrusting speed) of thrusting the cutter blade in the direction at right angles to the blade edge line, and v denotes the speed (horizontal speed) of the cutter blade moving parallel to the blade edge line.

As is known from this expression, the cutting resistance shows a change depending on the paper quality and the dummy point angle (effective wedge angle) β of the cutter blade, and there is the wedge angle β optimally suiting the paper quality. The paper cutting machine of the present invention takes the above expression into consideration, and includes a guide groove for controlling the optimum thrust speed V and horizontal speed v, and a slider fitting to the guide groove. Such inclusion is made based on the practical dimensions for equipping to office equipment or others, and the constraints such as the cutting time or others.

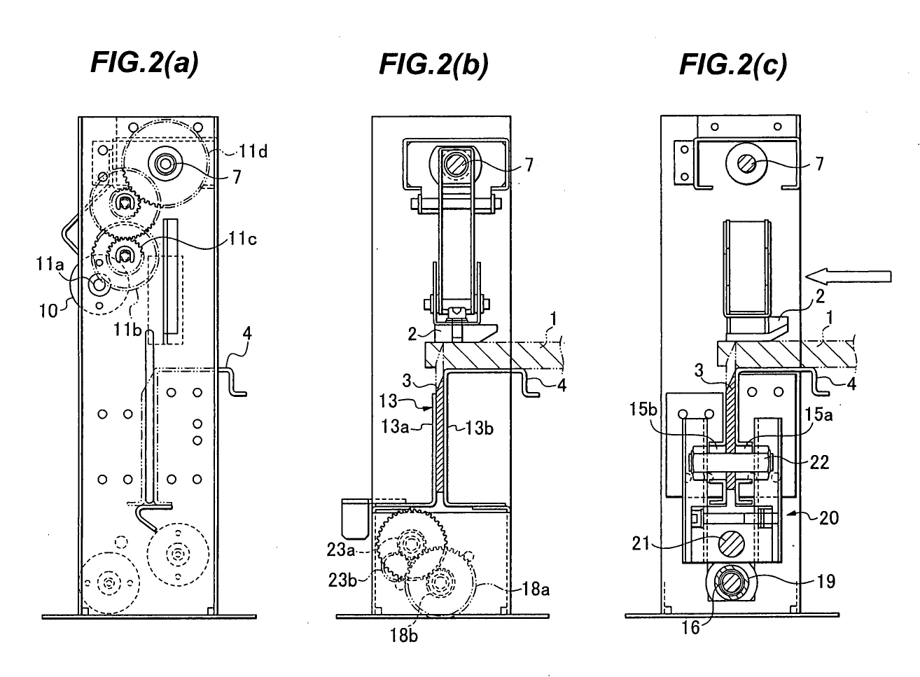

Herein, in the paper cutting machine of the present invention, the above-described cutter blade is moved up to cut the clamped paper sheets. At this time, the cutter blade 3 is vibrated at a low frequency for the purpose of reducing the power required for cutting, and saving the electric power consumption. The technique therefor varies, and the present invention adopts the mechanical oscillation mechanism with the aim for reducing the manufacture cost and stabilizing the operation. As FIG. 2(b) shows a cross sectional view cut along 2(b)-2(b) of FIG. 1, in a gear mechanism for the second motor 17 to rotate the second screw 16, eccentric gears 23a and 23b are combined together.

The eccentric gears 23a and 23b change the rotation speed of the second screw 16, and thereby, the moving element 20 does not move at the same speed, and changes the moving speed of the inner sliders 15a and 15b for sliding in the guide grooves 14a and 14b. Therefore, the cutter blade 3 moves with vibration, and the power required for cutting and the consumption of energy are both reduced. In this example, two eccentric gears 23a and 23b are used to transfer the constant-speed rotation of the second motor 17 to the second screw 16 as variable-speed rotation.

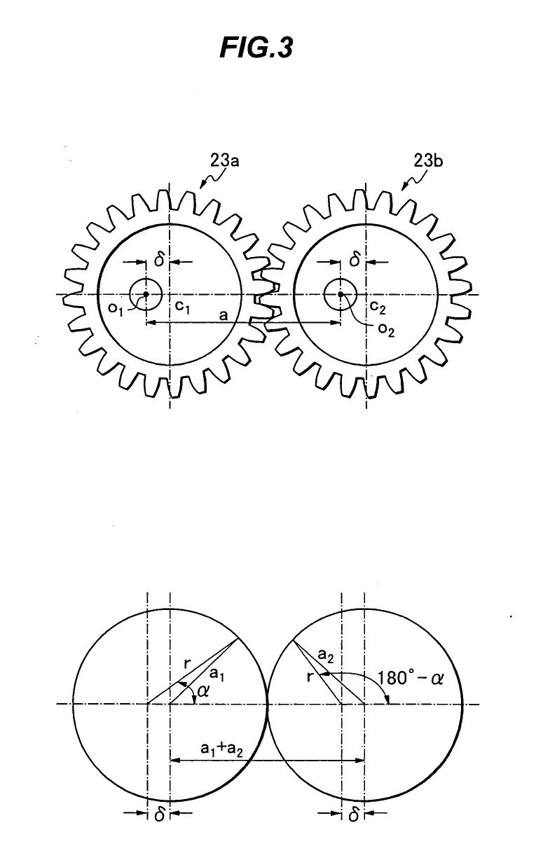

Here, as shown in FIG. 3, when the eccentric gears 23a and 23b are both a circular gear, the angular speed change ω₂/ω₁ of the eccentric gears 23a and 23b, the speed change V, and the center distance a₁+a₂ are expressed as follows:
Angular Speed Change: ω₂/ω₁=(1+ε)/(1−ε)˜(1−ε)/(1+ε)
Speed Change: V=2πfr(1±2δ/r)
Center Distance: a1+a2=2r˜2r+δ²/r
Herein, ε=2δ/(a₁+a₂)≅δ/r
where
   δ: an eccentric volume of the eccentric gears
   f: a rotation speed of the eccentric gears
   a₁: a radius of the eccentric gear 23a
   a₂: a radius of the eccentric gear 23b

Here, the center distance (a₁+a₂) between the above-described eccentric gears 23a and 23b is required to be larger than the reference center distance 2r by δ²/r. This is not applicable when the eccentric gear is not circular but elliptic, and there is no need to consider any change observed to the center distance for use. In response to the speed change V based on the eccentric gears 23a and 23b, the rotation speed of the second screw 16 changes, and the moving-up speed of the cutter blade 3 changes so that it is vibrated at the low frequency of a type.

A limit switch is used to detect the movement stop position of the cutter blade so that control is applied not to leave some paper sheets uncut. However, here is an issue that it is unavoidable any operation error with such an electrical control technique using the limit switch, and an attachment error of the limit switch, a manufacture error of attachment components, and others wield influences. As a result, the last paper sheet to be cut may be left uncut, or the cutter blade may dig into the rest surface of the paper holder more than necessary.

As a result, the life for use of the cutter blade is shortened, causing a difficulty of achieving stable paper cutting. When the electric control is not exercised right, the cutter blade digs into the rest surface so that the operation stops under emergency conditions. Even if so, the cutting machine is damaged, and resultantly becomes susceptible to further damage.

In consideration thereof, as below, a cutting machine of a second embodiment of the present invention is provided with a cutting blade positioning mechanism.

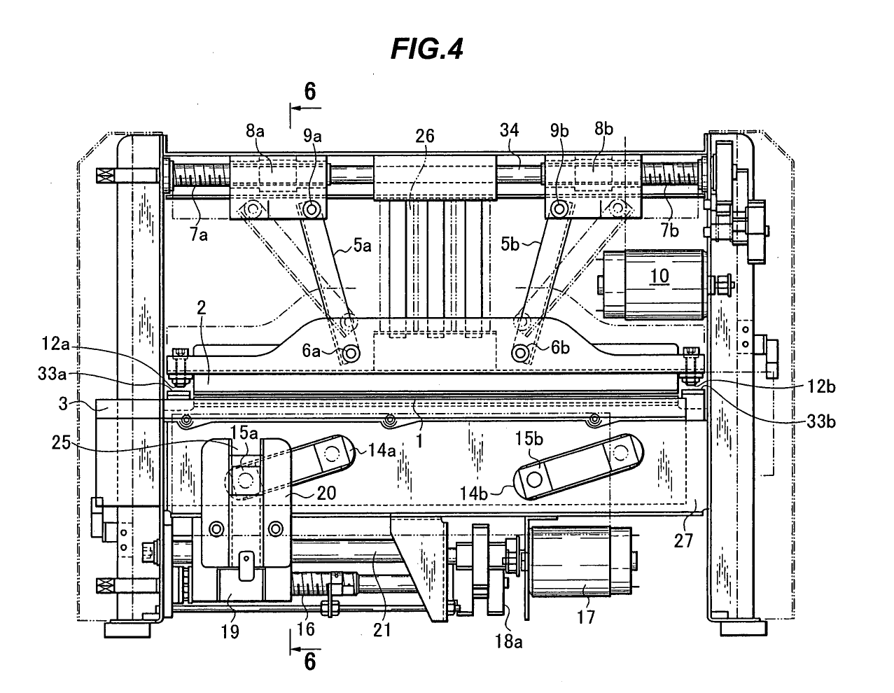

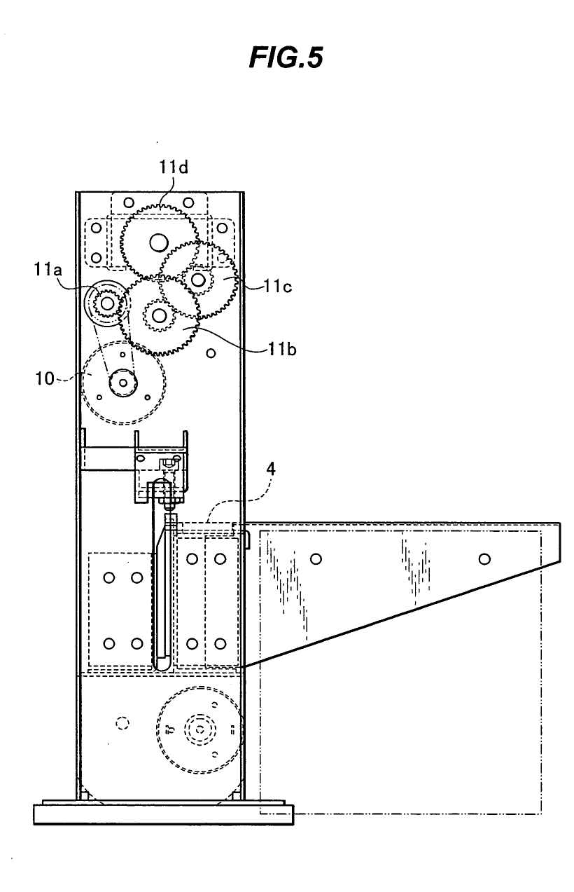

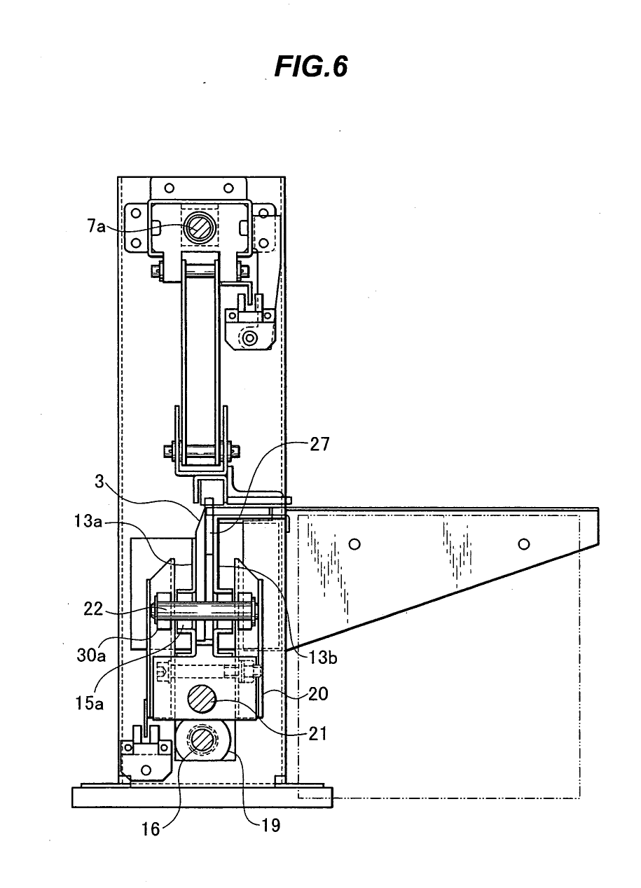

FIGS. 4 to 6 all shows a paper cutting machine of the second embodiment of the present invention, and specifically, FIG. 4 shows a front view thereof, FIG. 5 shows a side view thereof, and FIG. 6 shows a cross sectional view cut along 6-6 of FIG. 4. In the drawings, the reference numeral 1 denotes stacked plural paper sheets 1, the reference numeral 2 denotes a paper holder that serves to prevent the paper sheets 1 from being displaced, and the reference numeral 3 denotes a cutter blade for cutting the paper sheets 1. The stacked paper sheets 1 are placed on the flat table 4, and the paper holder 2 moves downward. The paper sheets 1 are thus firmly clamped by the paper holder 2 not to displace at the time of paper cutting.

The paper holder 2 is a rod-shaped member that is substantially inverted-U shape in cross section, and abuts the paper sheets entirely thereover. A link to the paper holder 2 is established by the links 5a and 5b, which are both placed equidistant from a neutral axis. Via the upper link axes 9a and 9b, respectively, the links 5a and 5b are linked to first nuts 8a and 8b, which are screwed to first screws 7a and 7b. The first screws 7a and 7b are provided at both ends of a drive axis 34, and the space between the first nuts 8a and 8b screwed to the first screws 7a and 7b, respectively, is increased or decreased in response to rotation of the drive axis 34. As a result, a change is observed to the slope angle of the links 5a, 5b,—which are coupled to the paper holder 2 via lower link axes 6a and 6b, and the upper link axes 9a and 9b.

In FIG. 4, in response to decrease of the space between the first nuts 8a and 8b, the paper holder 2 moves down to press the stack of paper sheets 1. As is guided by the vertical guide 31, the paper holder 2 does not move laterally but vertically when the first nuts 8a and 8b move responsively to rotation of the drive axis 34. The drive axis 34 is driven by the first motor 10 to rotate, and a plurality of upper gears 11a, 11b,—are disposed therebetween thereby allowing the drive axis 34 to rotate slowly in a reduced speed. Thereafter, the links 5a and 5b rise, and responsively the paper holder 2 starts moving down. At this time, the force of the links 5a and 5b pressing down the paper sheets is weak at an early stage with a gradual link slope compared with a steep link slope at a later stage. The paper holder 2 is biased with the spring force of pressing down coil springs 26 so that the force of pressing down the paper sheets becomes substantially equal between the early to later stages.

Also in this second embodiment, similarly to the first embodiment, the paper holder is a combination of a gear mechanism and a link mechanism. Accordingly, with the first motor 10 having a power supply of DC 24V equivalent to 25 W, for example, the paper sheets 1 can be firmly clamped. Moreover, through position detection of the first nuts 8a and 8b, the slope angle θ is known for the links 5a, 5b,—. As a result, the thickness can be known for the paper sheets 1 pressed by the paper holder 2 so that the cutter blade 3 can be controlled in movement amount for not to move for nothing.

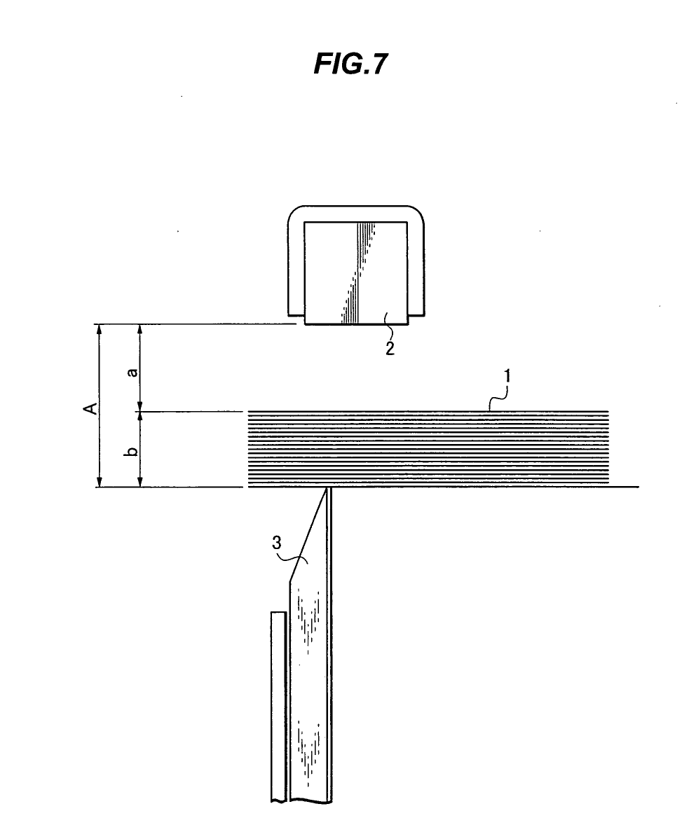

FIG. 7 is a diagram showing the relationship among the paper sheets 1, the paper holder 2, and the cutter blade 3, representing A maximum space for paper accommodation, a: movement distance for the paper holder, and b: movement distance for the cutter blade.

Herein, when the paper holder 2 moves down by the distance a, and presses down the paper sheets 1 with a fixed force, the first motor 10 receives a predetermined load. When the load is detected, the first motor 10 stops its operation instantaneously.

The cutter blade 3 then moves up, and cuts the paper sheets 1. First stopper pieces 12a and 12b abut second stopper pieces 33a and 33b, respectively. After the paper sheets 1 are cut, the paper holder 2 moves up and the cutter blade 3 moves down.

With this being the case, when paper cutting is repeated for several times due to a thin stack of the paper sheets 1, it may be controlled for the paper holder 2 not to return by the distance a but by a distance needed for exchanging the stack of paper sheets 1 thereby shortening the time more.

On the other hand, the cutter blade 3 is so attached as to come beneath the paper holder 2 while being in surface contact with a cutter base 27, and is slid while being sandwiched between the guides 13a and 13b. What is more, the cutter blade 3 is slid in the diagonal direction, and the guides 13a and 13b are respectively formed with the guide grooves 14a and 14b with a predetermined space therebetween. These guide grooves 14a and 14b are extending in the diagonal direction.

As shown in FIG. 6, the axis pin 22 goes through the cutter blade 3 and the cutter base 27, and the axis pin 22 thus protruding to both sides is attached with inner sliders 15a and 15b. At a tip portion of the axis pin 22, an outer slider 30a is attached. The inner sliders 15a and 15b are fitting in the guide grooves 14a and 14b, and the outer slider 30a is fitting in the vertical groove 25, which is provided to the moving element 20.

The cutter blade 3 is formed with a circular hole so that the axis pin 22 goes through the circular hole. In response to movement of the inner sliders 15a and 15b along the guide grooves 14a and 14b, the cutter blade 3 is allowed to slide in the diagonal direction. However, the cutter blade 3 always remains horizontal to make a movement with such a configuration that the inner sliders 15a and 15b move while fitting in the guide grooves 14a and 14b, which are formed parallel. When the inner sliders 15a and 15b are located on the left ends of the diagonally-placed guide grooves 14a and 14b, the cutter blade 3 is at its lower position. In response to sliding and moving of the inner sliders 15a and 15b in the right direction, the cutter blade 3 moves up.

The second screw 16 is attached horizontally beneath the cutter blade 3, and the second screw 16 is driven to rotate by the second motor 17 via a plurality of lower gears 18a, 18b,—. The second nut 19 screwed to the second screw 16 is allowed to make a movement in response to rotation of the second screw 16. The moving element 20 rises from the second nut 19 and is coupled with the inner slider 15a. That is, the moving element 20 is formed with the vertical groove 25, and the vertical groove 25 is engaged with the outer slider 30a. The square-shaped outer slider 30a and the inner slider 15a are coupled together by the axis pin 22, and what is more, these sliders 15a and 30a are allowed to rotate with some constraints by the orientation of the guide groove 14a and the vertical groove 25.

The moving element 20 is allowed to move along the guide rod 21, which is provided parallel to the second screw 16. That is, the second screw 16 is rotated by the second motor 17, and the second nut 19 moves in response to rotation of the second screw 16. The moving element 20 attached with the second nut 19 moves along the guide rod 21. Although the moving element 20 moves in the horizontal direction along the guide rod 21, the axis pin 22 moves in the vertical direction together with the outer slider 30a along the vertical groove 25, and slides the inner slider 15a along the guide groove 14a so that the cutter blade 3 moves up and down in the diagonal direction.

Accordingly, the cutter blade 3 is pushed up in the diagonal direction along the guide grooves 14a and 14b, and thus becomes capable of cutting the paper sheets 1 clamped by the paper holder 2 from the stack bottom, sheet by sheet. By paper cutting on a paper sheet basis as such, the paper scraps of the paper sheets 1 soon fall without rubbing against the blade edge surface, whereby the blade edge is attached with no paper scrap. Here, at the time of cutting the paper sheets 1, the cutter blade 3 moves up and simultaneously moves in the lateral direction, and accordingly the links 5a and 5b serve well for firm clamping by the paper holder 2 to prevent the clamped paper sheets 1 from being displaced.

Incidentally, sharpness of the cutter blade is better with the smaller cutting resistance between the cutter blade and the paper sheets. There are two cutting methods; one is “thrust cutting” technique in which the cutter blade is thrust in the direction at right angles to the blade edge line, and the other is “pull cutting” technique in which the cutter blade is thrust while moving parallel to the blade edge line. The present invention applies a method emphasizing the latter “pull cutting” technique. Herein, the dummy point angle (effective wedge angle) β of the cutter blade is represented by the following expression:
tan β=V/(V²+v²)^{1/2}·tan γ

where γ denotes the point angle (wedge angle) of the cutter blade, V denotes the speed (thrusting speed) of thrusting the cutter blade in the direction at right angles to the blade edge line, and v denotes the speed (horizontal speed) of the cutter blade moving parallel to the blade edge line.

As is known from this expression, the cutting resistance shows a change depending on the paper quality and the dummy point angle (effective wedge angle) β of the cutter blade, and there is the wedge angle β optimally suiting the paper quality. The paper cutting machine of the present invention takes the above expression into consideration, and includes a guide groove for controlling the optimum thrust speed V and horizontal speed v, and a slider fitting to the guide groove. Such inclusion is made based on the practical dimensions for equipping to office equipment or others, and the constraints such as the cutting time or others.

With the paper cutting machine of the present invention, the above-described cutter blade is moved up to cut the clamped paper sheets. In order not to leave the paper sheets 1 uncut due to the reason that the blade edge of the cutter blade 3 not reaching the paper holder 2, or in order not to cause the blade edge of the cutter blade 3 to dig too much into the rest surface of the paper holder 2, a stopper is provided.

The first stopper pieces 12a and 12b are attached at both sides of the paper holder 2, and these first stopper pieces 12a and 12b configure a screw mechanism. Therefore, their tip positions can be adjustable. The cutter base 27 being in surface contact with the cutter blade 3 is attached with the second stopper pieces 33a and 33b, and when the cutter blade 3 moves up and reaches at its predetermined position, the second stopper pieces 33a and 33b abut the first stopper pieces 12a ad 12b attached to the paper holder 2 so that the cutter blade 3 is prevented from going up any further. Here, although the cutter blade 3 moves up in the diagonal direction, the cutter base 27 moves up in the vertical direction so that the second stopper pieces 33a and 33b can abut the first stoppers 12a and 12b.

When the cutter blade 3 moves up, and the second stopper pieces 33a and 33b abut to the first stopper pieces 12a and 12b, the second motor 17 receives the load larger than determined for moving up the cutter blade 3. When this load reaches the determined value or more, the second motor 17 is controlled to stop rotation without leaving some of the paper sheets 1 uncut, or causing the blade edge of the cutter blade 3 to dig too much into the rest surface of the paper holder.

Although the cutter blade 3 moves up in the diagonal direction, the cutter blade 3 always moves horizontal because the inner sliders 15a and 15b move while fitting in the guide grooves 14a and 14b with some play. Theoretically, the blade edge of the cutter blade 3 entirely abuts the paper holder 2. However, the blade edge of the cutter blade 3 never abuts entirely the paper holder 2 due to influences of clearances with the inner sliders 15a and 15b fitting in the guide grooves 14a and 14b with some play, or influences of dimension error such as attachment accuracy of the inner sliders 15a and 15b.

In the present invention, a stopper is provided, and when the second stopper pieces 33a and 33b abut the first stoppers 12a and 12b, the slightly tilting blade edge of the cutter blade 3 can be put back to be horizontal. Accordingly, this enables to cut all of the paper sheets 1 without causing one-side blade edge of the cutter blade 3 to dig into the rest surface of the paper holder 2. There surely needs to adjust the screws of the first stopper pieces 12a and 12b to be horizontal to the rest surface.

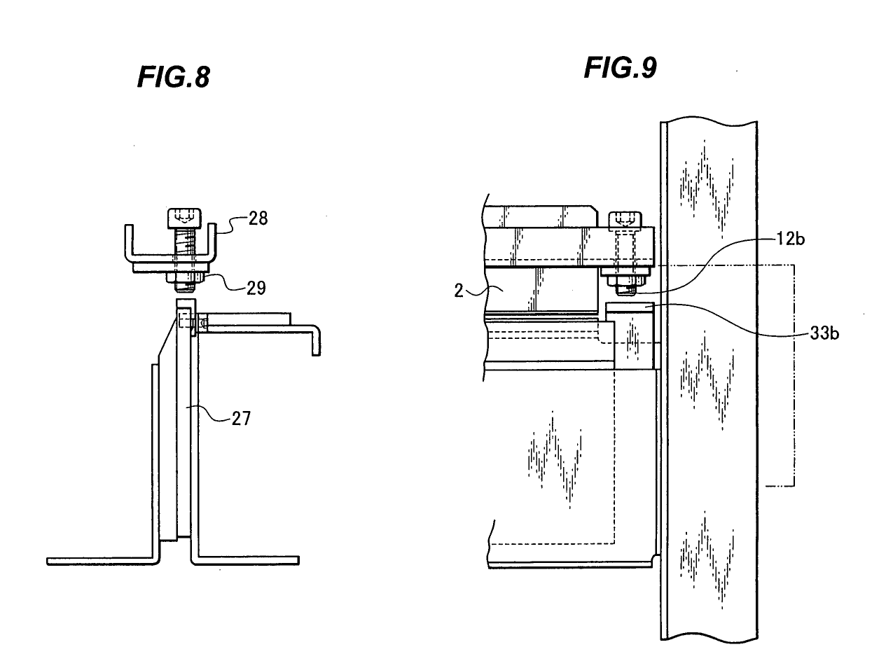

As shown in FIGS. 8 and 9 with the enlarged view of the stopper, the first stoppers 12a and 12b are attached to an attachment base 28 of the paper holder 2 by being screwed thereinto, and locked by a lock nut 29 not to loose after adjusting their protruding length. The second stopper pieces 33a and 33b attached to the lower cutter base 27 are each configured by a block member. When the cutter blade 3 moves up, the second stoppers 33a and 33b abut the first stopper pieces 12a and 12b so that the cutter blade 3 is defined by top dead center. In this view, the first stopper pieces 12a and 12b, and the second stopper pieces 33a and 33b are made of a material that is resistant to deformation and wear-out even with such abutment.

As described in the foregoing, the paper cutting machine of the present invention includes a paper-holding mechanism in which a nut to be screwed to a screw is coupled with a paper holder. Therein, a cutter blade is attached to a guide, and the guide is formed with a diagonal guide groove for fitting therein a slider that is protruding from the cutter blade. This slider is engaged with a moving element that is coupled with the nut screwed to the screw. The cutter blade is vibrated at a low frequency, and the following effects can be achieved.

(1) The paper holding mechanism of the paper holder configures a so-called toggle mechanism as a combination of a screw and a link. This configuration allows a small-sized motor to firmly clamp the stacked paper sheets, and prevents thus clamped stacked paper sheets from being displaced. The toggle mechanism is also used to move up and down the cutter blade with a nut screwed to a screw therein to cut the paper sheets from the stack bottom, sheet by sheet. This configuration only needs a low driving force, enabling paper cutting with a small-sized motor.

(2) In the present invention, the cutter blade is vibrated at a low frequency. This reduces the cutting resistance on the cutter blade, and thus the sharpness of the cutter blade can be increased. Accordingly, compared with a case of paper cutting without vibration, this reduces the consumption energy, and eases to smoothly perform paper cutting with a small-sized motor. The vibration also effectively prevents the blade edge from being attached with paper scraps. What is more, because this vibration mechanism is of a mechanical configuration, this stabilizes the operation, and reduces the manufacture cost.

(3) The paper holding mechanism is located at the upper side of the table, and the cutter blade and the drive mechanism thereof are located at the lower side of the table. With such a configuration, compared with a conventional machine in which both of those are placed at the upper side, the device can be reduced in volume and compact in size.

(4) A cutter blade whose blade edge is parallel to the paper surface is used to cut the stacked paper sheets from the stack bottom, sheet by sheet. By operating the cutter blade to make a stroke in accordance with the thickness of the stacked paper sheets placed on the table, the cutting operation can be efficiently performed. In the practical operation, through detection of the link slope of the paper holder, or through position detection of a nut screwed to a screw, the thickness of the stacked paper sheets placed on the table can be known. As a result, the movement range for the cutter blade to slide is known in advance so that the cutter blade never moves for nothing any more. That is, the cutter blade needs to slide minimum, and the cutting operation can be increased in efficiency.

(5) With paper cutting from the stack bottom, sheet by sheet, thanks to a blade edge parallel to the paper surface, the paper scraps are not curled at the time of paper cutting as with paper cutting with a conventional tilted blade edge. Therefore, the resulting scrap pieces will not be of quite a large amount. What is more, there is no table at where the paper scraps are to be produced so that the paper scraps freely fall right after cutting. With such a configuration, the small paper scraps do not remain on the table, or remain in the vicinity of the cutter blade and keep sticking thereto. Accordingly, no static buildup is caused as the paper scraps do not rub against the blade edge surface, and no cut pieces of the paper scraps attach the blade edge. As such, no such inconvenience that has been popular with the conventional machine occurs.

(6) Because a stopper mechanism is provided to the cutter blade, no paper sheets are left uncut, and the cutter blade is prevented from digging too much into the rest surface of the paper holder. Therefore, the paper cutting can be performed with stability, and the cutter blade can be greatly increased in its useful life with no unnecessary strain thereon. What is more, by the abutment of the stopper pieces attached to the paper holder and the cutter base at their respective sides, even if the cutter blade may be slightly tilted at its edge due to some play between the slider and the guide groove, the cutter blade is always put back to be horizontal so as not to abut the rest surface of the paper holder, favorably preventing one-side digging of the cutter blade.

### INDUSTRIAL APPLICABILITY

As described above, a paper cutting machine of the present invention works useful to cut stacked plural paper sheets, and especially, reduces the size quite compact. Therefore, it is considered suitable to use as an auxiliary device for office equipment.

1. A vibration-type paper cutting machine, comprising:
a table for placing thereon stacked plural paper sheets;
a cutter blade having blade edge at an upper end parallel to a paper-placed surface of the table, and being placed beneath the table;
a paper holder that freely moves up and down to move downward for pressing down the stacked paper sheets;
a vertical guide for sandwiching the paper holder in a vertical direction to freely slide up and down in contact therewith;
a first motor for driving the paper holder;
a first screw to be rotated by the first motor;
a first nut screwed to the first screw;
a link for coupling the first nut with the paper holder;
a pair of guides each having a diagonally-extending guide groove, and sandwiching the cutter blade in the guide groove to freely slide in contact therewith;
a slider protruding from the cutter blade vertically to a surface of the cutter blade to engage with the guide groove; and
a mechanism for vibrating the slider at a low frequency in a direction along the guide groove;
whereby the cutter blade is allowed to move up and down while vibrating at the low frequency in the direction along the guide groove.

2. The vibration-type paper cutting machine according to claim 1, wherein
the slider is configured by engaging with and coupling to a vertical groove that is formed to a moving element coupled to be a piece with a second nut, which is screwed to a second screw to be rotated by a second motor.

3. The vibration-type paper cutting machine according to claim 2, wherein the mechanism for vibrating at a low frequency is configured by a gear mechanism for changing a rotation speed of the second screw.

4. The vibration-type paper cutting machine according to claim 3, wherein
the gear mechanism for changing the rotation speed of the second screw includes a pair of eccentric gears.

5. The vibration-type paper cutting machine according to claim 4, wherein
an angular speed change ω₂/ω₁ of the eccentric gears, a speed change V, and a center distance a₁+a₂ are expressed by an expression below;
Angular Speed Change: ω₂/ω₁=(1+ε)/(1−ε)˜(1−ε)/(1+ε)
Speed Change: V=2πfr (1±2δ/r)
Center Distance: a₁+a₂=2r˜2r+δ²/r
Herein, ε=2δ/(a₁+a₂)≅δ/r
where
δ: an eccentric volume of the eccentric gears
f: a rotation speed of the eccentric gears
a₁: a radius of an eccentric gear 23a
a₂: a radius of an eccentric gear 23b.

6. The vibration-type paper cutting machine according to claim 1, further comprising
a cutter base for moving up and down in response to vertical motion of the cutter blade while being in surface contact with the cutter blade, wherein
a first stopper piece is attached at both ends of the paper holder,
a second stopper piece is attached at both upper ends of the cutter base, and
when the cutter blade moves up and reaches at a predetermined position, the first and second stopper pieces abut each other.

7. The vibration-type paper cutting machine according to claim 6, wherein
one side of the first stopper pieces and the second stopper pieces is configured as a screw mechanism, thereby enabling a blade edge of the cutter blade to be adjusted in position when the stopper pieces abut thereto.
